(19) United States
(12) Patent Application Publication
(10) Pub. No.: US 2004/0026975 A1
(43) Pub. Date: Feb. 12, 2004

(54) Motor vehicle seat

(76) Inventors: Peter Rausch, Coburg (DE); Wolfgang Suck, Coburg (DE); Christina Schwerdtner, Neustadt (DE)

Correspondence Address: CHRISTIE, PARKER & HALE, LLP, 350 WEST COLORADO BOULEVARD, SUITE 500, PASADENA, CA, 91105, US

(21) Appl. No.: 10/416,098

(22) PCT Filed: Nov. 13, 2001
(86) PCT No.: PCT/DE01/04276

(30) Foreign Application Priority Data
Nov. 15, 2000 (DE) 100 57 721.0

(51) Int. Cl. B60N 2/12

(52) U.S. Cl. 297/344.1

(57) ABSTRACT

The invention relates to a motor vehicle seat comprising a seat frame (G); a backrest (R), which is pivotably mounted on the seat frame (G) and which may be folded from the working position thereof in the direction of a seating surface on the seat frame (G); a longitudinal guide (101, 102), with which the seat frame (G) may be moved to adjust the seat longitudinal position in the seat longitudinal direction (L), a fixing device (120) for fixing the seat frame (G) in a pre-determined seat longitudinal position; an operating element (120b) for releasing the fixing device (120), such that the seat frame (G) may be moved in the seat longitudinal direction (L); a coupling mechanism, acting on the operating element (120b) and releasing the fixing device (120), when the backrest (R) is folded on the seat surface; a memory device (104, 105, 107), by means of which, during a movement in the seat longitudinal direction, the seat frame (G) can be automatically retained in a pre-determined seat longitudinal position, defined as the memory position; adjuster means (105) for the memory device (104, 105, 107), with which the memory position may be adjusted in the seat longitudinal direction (L); a locking device (104, 107) for the memory device (104, 105, 107), for locking an adjusted memory position and means (203, 206) for coupling the locking device (104, 107) to the backrest (R). According to the invention, a catch (203) is displaceably mounted on the seat frame (G), which, with the backrest (R) in the operating position thereof, engages with the memory device (104, 105, 107) such that the memory position is adjusted along with the seat frame (G) on setting the seat longitudinal position. A catch actuator (261) is provided, coupled to the backrest (R) in such a way that on folding the backrest (R) the catch (203) is lifted clear of the memory device (104, 105, 107).

### CROSS-REFERENCE TO RELATED APPLICATION

This application is a National Phase Patent Application of International Application Number PCT/DE01/04276, filed on Nov. 13, 2001, which claims priority of German Patent Application Number 100 57 721.0, filed Nov. 15, 2000.

### DESCRIPTION

The invention relates to a motor vehicle seat according to the preamble of patent claim 1.

This comprises for example a seat frame, a seat surface provided on the seat frame, and a backrest which is mounted for swivel movement on the seat frame and which can be folded forwards towards the seat surface.

Seats of this kind are used as front seats in motor vehicles whereby on folding the backrest forwards it becomes easier for a passenger to climb into the back of the vehicle or place an object in the back of the vehicle. It becomes even easier to climb in, particularly in the case of two-door vehicles, if the after the backrest has been folded forwards the seat can be moved forwards. For this the vehicle seat has the following:

a longitudinal guide with which the seat frame can be moved in the longitudinal direction of the seat in order to adjust the longitudinal position of the seat;

a fixing device for locking the seat frame in a previously set longitudinal seat position;

an operating element for unlocking the fixing device so that the seat frame can be moved in the longitudinal direction of the seat;

a coupling mechanism for coupling the fixing device to the backrest and acting on the operating element and thereby releasing the fixing device when the backrest has been folded forwards towards the seat surface;

a memory device by means of which on moving the seat frame in the longitudinal direction it can be automatically stopped in a predeterminable longitudinal seat position defined as the memory position whereby a stop which is associated with the seat frame and which is movable in the longitudinal direction of the seat enters into engagement with a counter stop of the memory device;

adjusting means for the memory device with which the memory position can be adjusted in the longitudinal direction of the seat by moving the position of the counter stop;

a locking device for the memory device for locking a set memory position; and

switch means by which the locking device can be unlocked in order that the memory position can be adjusted.

A seat of this kind known from WO 00/55002 offers on the one hand the possibility after folding the backrest forwards towards the seat surface of moving the seat frame, and thus the entire vehicle seat, forwards, in order to make it easier for a passenger to enter into the back (easy-entry function). At the same time the seat can then be moved very simply again into its original longitudinal position when this position is stored as a memory position by means of the memory device provided for this purpose. In this case the seat frame is automatically stopped in the memory position as the seat is pushed back whereby a stop associated with the seat frame interacts with a counter stop of the memory device.

The object of the invention is to improve a motor vehicle seat of the kind already mentioned, more particularly to enable compact construction of the arrangement with regard to the easy-entry function.

This is achieved according to the invention by providing a vehicle seat having the features of patent claim 1.

According to this a catch is mounted movable on the seat frame and when the backrest is located in the use position (i.e. not folded forwards onto the seat surface) acts on the memory device so that during an adjustment of the seat longitudinal position the memory position is displaced together with the seat frame, and furthermore a catch actuator is provided coupled to the backrest to lift the catch from the memory device when the backrest is folded forwards onto the seat surface. The catch actuator thereby preferably interacts positively with the memory device in order to undertake adjustment of the memory position when setting the longitudinal seat position.

By use position of the backrest is thereby meant a position in which this has such an incline relative to the substantially horizontal seat surface that the support of the back of an occupant sitting on the seat is possible. In order to implement easy-entry function the seat has to be folded forwards from such a use position towards the seat surface.

The solution according to the invention thus provides a very compact construction of the structural assemblies provided for producing the easy-entry function , as will be explained below in the description of the dependent claims and in the description of the embodiments with reference to the drawings.

In a preferred embodiment of the invention the catch when acting on the memory device also releases the locking device at the same time.

The catch can be pretensioned by means of an elastic element for acting on the memory device so that this has to be lifted with the catch actuator each time actively from the memory device in order to stop the action of the catch on the memory device.

The locking device for the memory device preferably consists of a locking unit which is displaceable together with the counter stop of the memory device in the seat longitudinal direction and of a detent device associated with the locking unit and having detent spots arranged in succession in the longitudinal seat direction where the locking unit can be locked relative to the detent device for fixing the memory position.

The locking unit can comprise for example a swivel mounted locking pawl which has a detent element which can engage in the detent spots of the detent device whereby the locking pawl is provided with an operating section on which the switch means can act in order that the detent element can engage in and disengage from the detent device.

The catch is hereby preferably acting on the locking unit and in particular on its locking pawl which is designed accordingly. Thus a stop can be provided on the locking pawl on which the catch acts when the backrest is located in a use position so that the locking unit of the memory device can be entrained during adjusting of the seat longitudinal position.

The catch actuator can be simply formed by a lever.

The locking device for the memory device is in a preferred embodiment designed so that it is automatically locked when the catch does not act on same. This can be achieved for example by an elastic pretensioning of the locking device. The locking device is in this case each time only then released when the catch acts on same.

Furthermore a holding element can be provided on the seat frame with which the catch can be fixed in the position in which it is lifted clear of the memory device, thus is located out of engagement with the memory device. This holding element is preferably pretensioned in the direction of the catch whereby the memory device has a stop which prevents the fixing of the catch by the holding element when the seat frame is in the memory position. The fixing of the catch is then only possible when the seat has been moved out from its memory position.

The fixing of the memory position by means of the locking device is as a rule carried out not steplessly but stepped through a number of detent spots at which each time a locking of the memory device takes place and thus fixing of the memory position. This can lead to problems when the seat longitudinal adjustment enables at the same time a continuously variable setting of the seat longitudinal position. For then as a rule it happens that a seat user moves the seat into a longitudinal position and would like to lock it there where locking of the (non stepless) memory device is not possible. In such a case it must be ensured that after triggering the easy-entry-function (by folding the backrest forwards onto the seat surface) from a position in which the memory device is not locked, because the longitudinal seat position actually set was not allocated any corresponding detent spot of the locking device, this locking can be made up. To this end according to the invention the memory device has a stop which in the non locked state of the memory device interacts with an associated stop of the seat frame (which can be provided e.g. on the seat-side rail of the longitudinal guide) so that the parts of the memory device movable in the seat longitudinal direction are entrained at first when sliding the seat forwards with the backrest folded forwards until the locking device for the memory device snaps against the next detent spot and is thereby locked. With this snap engagement and locking of the locking device the corresponding stop is moved so that it is no longer in engagement with the associated stop on the seat frame side. The seat frame can then be moved further in the seat longitudinal direction whereby the memory device remains in the previously locked memory position.

The solution according to the invention enables a very compact arrangement of all the structural groups which ensure the easy-entry function, including the memory device and the fixing device for the longitudinal adjustment of the seat. In particular the memory device can hereby be completely mounted inside the space enclosed by the rails of the longitudinal guide.

Further features and advantages of the invention will now be explained with reference to the embodiment illustrated in the drawings in which:

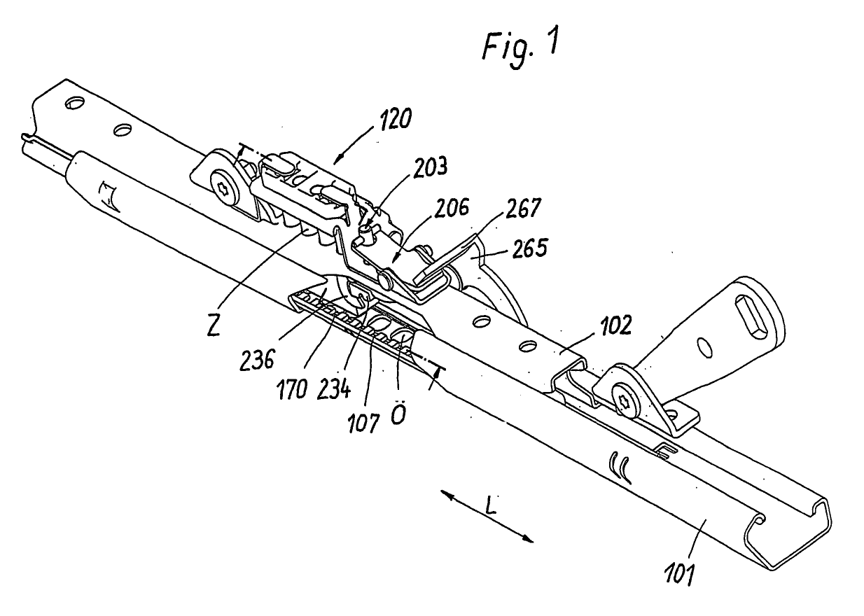

FIG. 1 shows a perspective view of parts of a seat frame with a seat longitudinal guide, a fixing device for the seat longitudinal guide and a programmable memory device for automatically locating a predetermined seat longitudinal position;

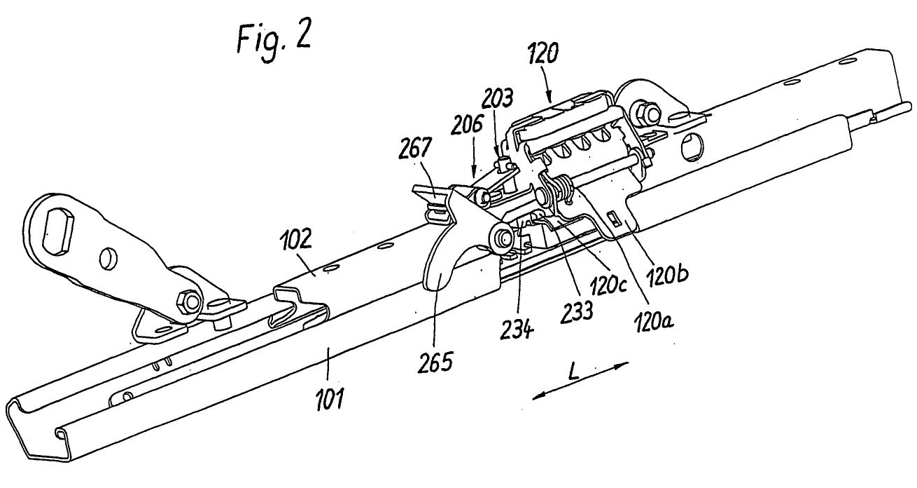

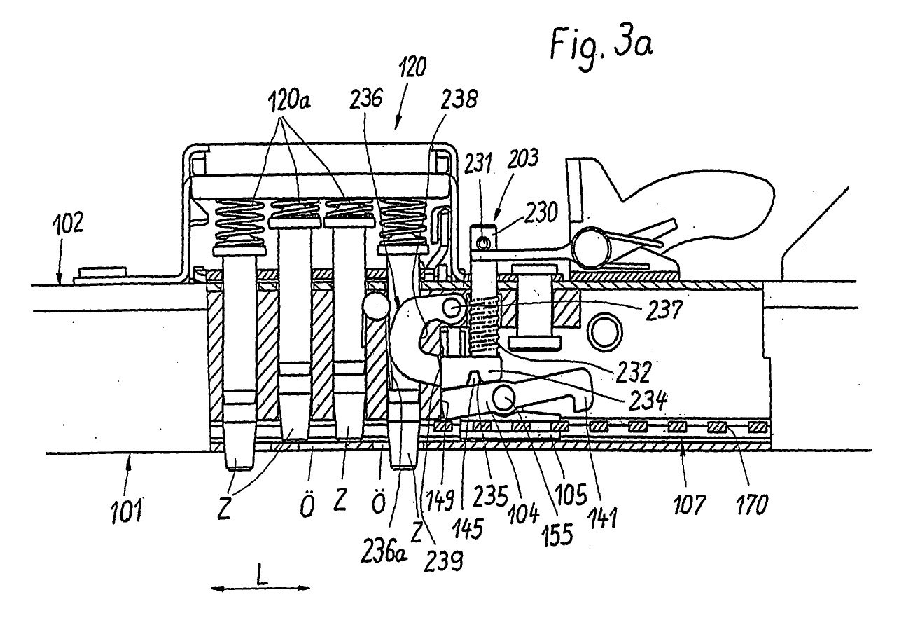

FIG. 2 shows a second perspective view of the arrangement according to FIG. 1;

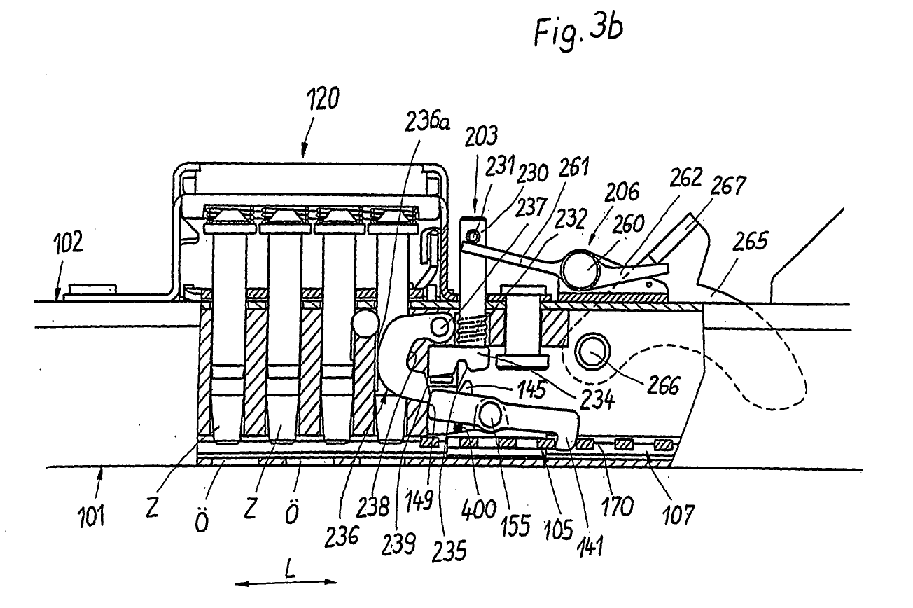

FIG. 3a shows a detail of FIG. 1 in longitudinal sectional view, in a state in which the seat is locked in its memory position with the backrest raised up;

FIG. 3b shows a detail of the arrangement of FIG. 1 in longitudinal section in a situation where the backrest has been folded forwards towards the seat surface, but the seat is still however in the memory position;

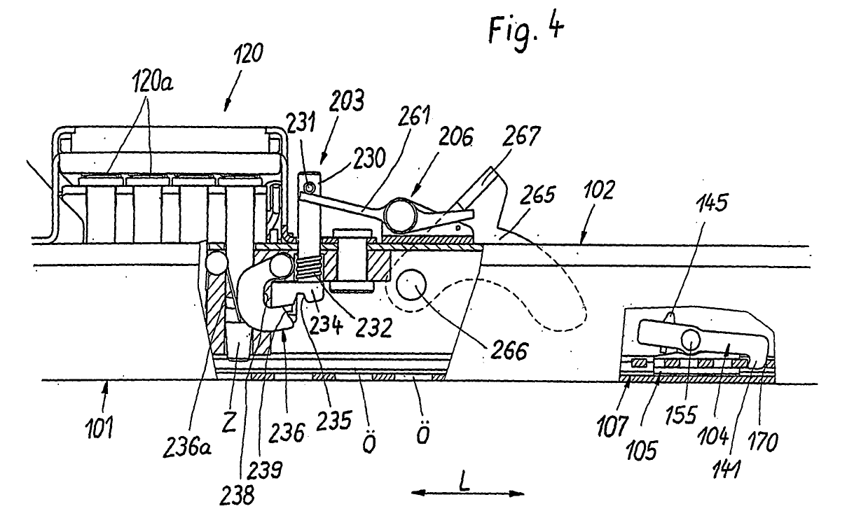

FIG. 4 shows a view according to FIG. 3b where the seat is located outside of the memory position;

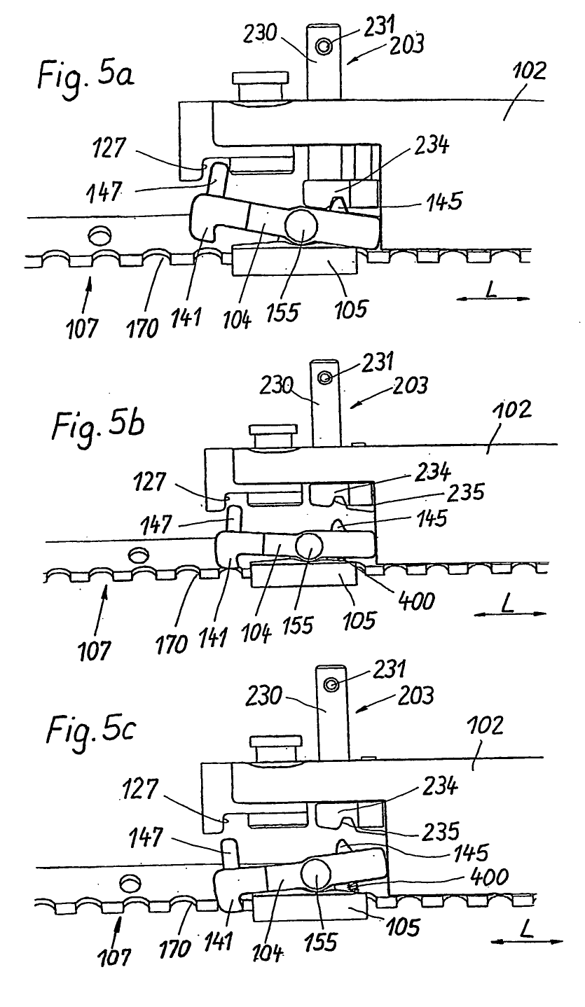

FIGS. 5a-5c show a diagrammatic view of a further development of the embodiment of FIGS. 1 to 4;

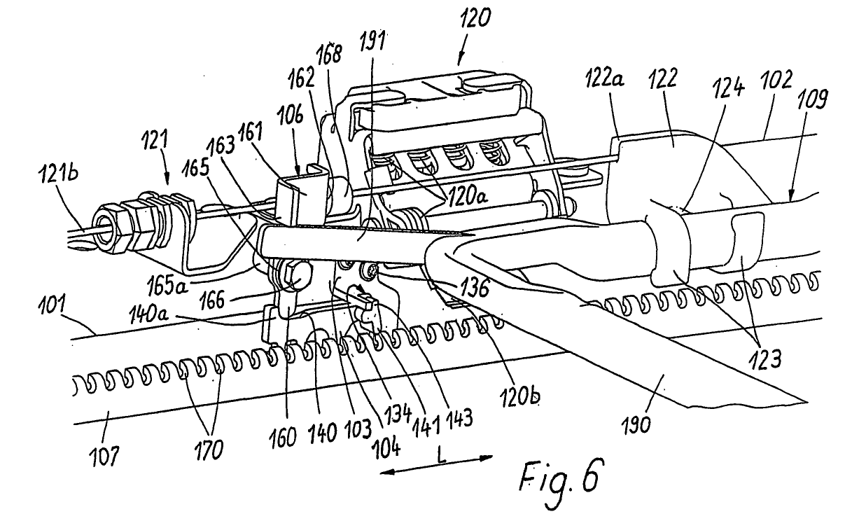

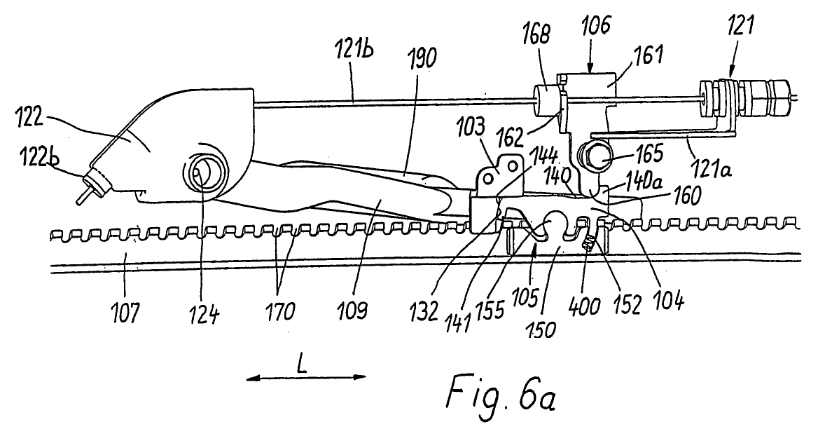

FIG. 6 shows a perspective view of a seat frame known from the prior art in a situation where the seat is locked with its raised backrest in its memory position;

FIG. 6a shows a rear view of the illustration in FIG. 6;

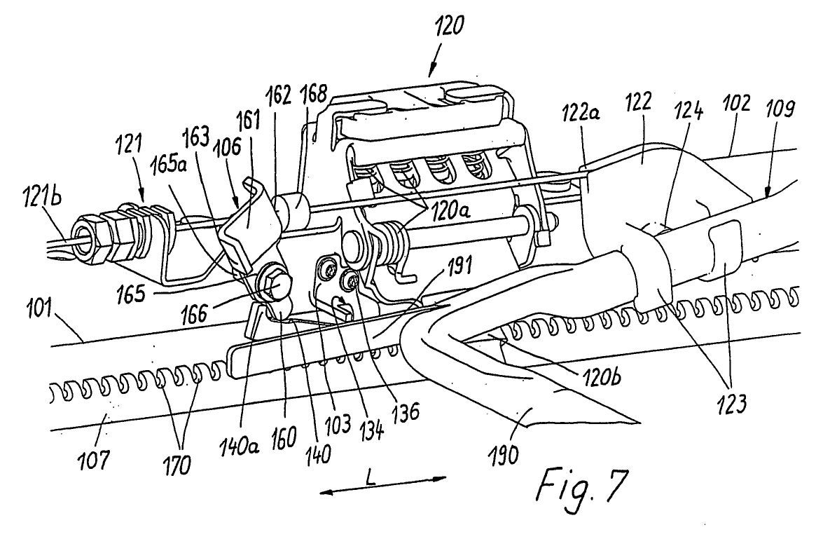

FIG. 7 shows a view according to FIG. 6 in a situation where the backrest has been folded forwards in order that the seat can be displaced with the backrest folded forwards;

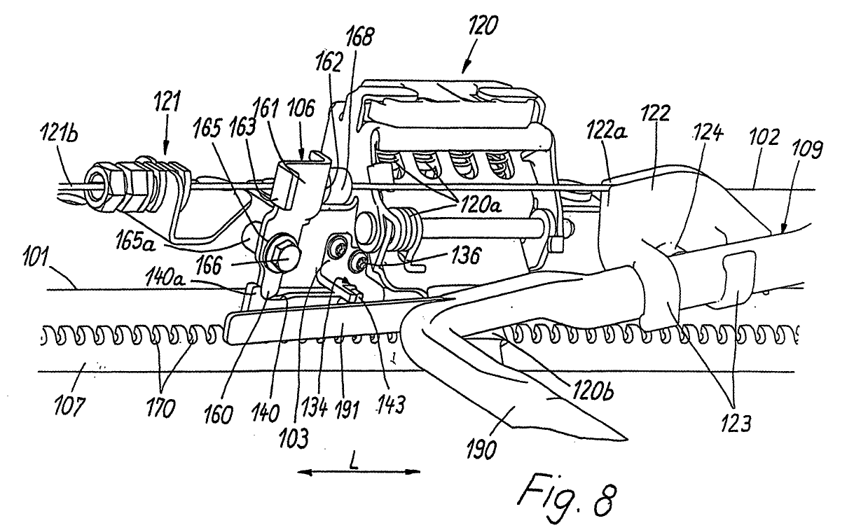

FIG. 8 shows a view according to FIG. 6 in a situation where with the backrest raised up in the memory position an actuating lever was operated in order to re-set the memory position;

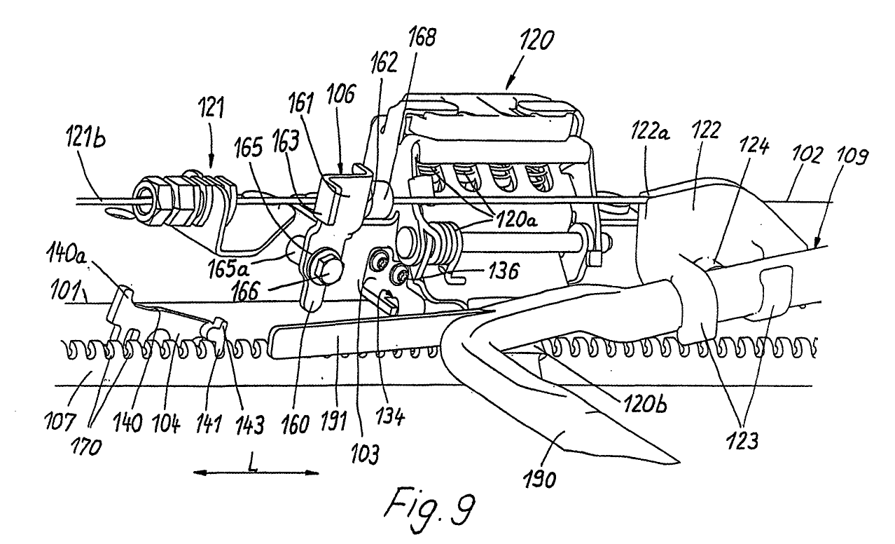

FIG. 9 shows a view according to FIG. 6 in a situation where the memory position of the seat is arrived at with the backrest raised up;

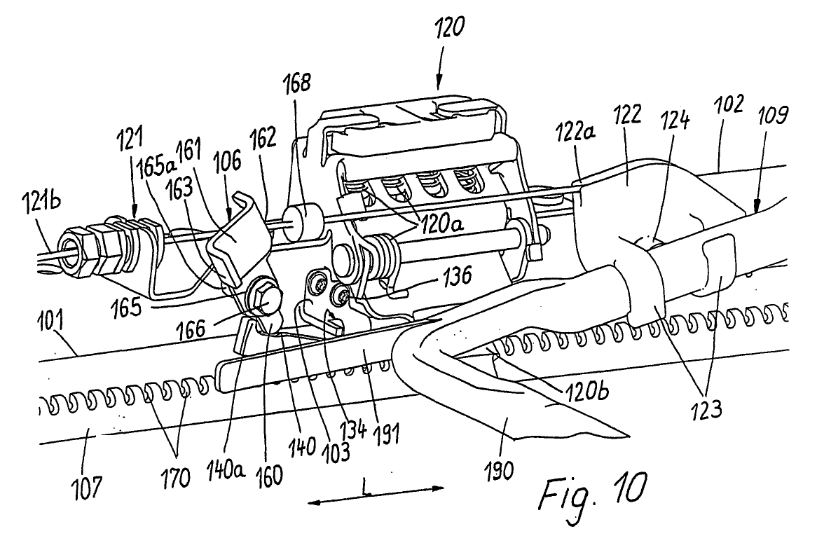

FIG. 10 shows a view according to FIG. 6 in a situation where the memory position of the seat is reached with the backrest raised up;

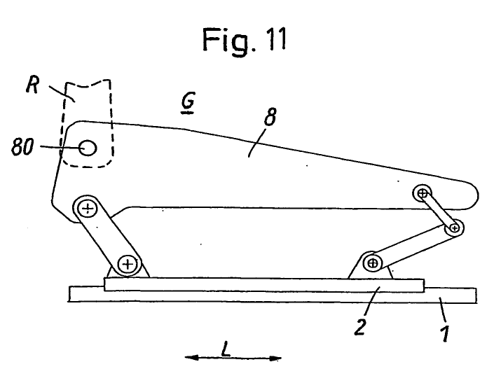

FIG. 11 shows a diagrammatic view of a seat frame.

The seat frame G (underneath frame) illustrated in a side view in FIG. 11 comprises a seat rail 2 which is mounted movable in the seat longitudinal direction L on a lower rail 1 which is to be fixed on the vehicle body, and a seat side part 8 which is attached vertically adjustable on the seat rail 2 through front and rear articulated levers. On its other longitudinal side (not visible in FIG. 11) the seat frame G has a corresponding assembly. A seat surface extends between the two seat side parts of the seat frame G and holds a seat cushion on which a vehicle occupant can take his place.

Furthermore the side parts 8 of the seat frame G each have a bearing site 80 for swivel mounting a backrest R which is shown in dotted lines in FIG. 11.

Here as parts of the seat frame are meant all those component parts which are movable in the longitudinal direction of the seat on the lower rail 1 fixed on the body, thus in particular the seat rail 2, the seat side part 8 as well as the further component parts of the seat connected therewith.

If a vehicle seat of this kind which is adjustable in the longitudinal direction L is used for a two-door vehicle then it is known in order to facility entry into the back of the vehicle to couple the backrest to the seat longitudinal adjuster namely so that when the backrest R is folded forwards towards the seat surface which extends between the seat side parts 8 a fixing device associated with the seat longitudinal guide 1, 2 is released and the seat can be pushed forwards with the backrest folded forwards. This is a so-called easy-entry function.

In the following the basic principle of the easy-entry function when using a programmable memory device for automatically locating a predeterminable seat longitudinal position will be explained first using a seat assembly illustrated in FIGS. 6 to 10 and known from WO 00/55002. For further details on this reference is made to the WO 00/55002 which expressly pertains to the subject of the present description.

The perspective front view according to FIG. 6 as well as the associated rear view according to FIG. 6a show a rail 101 fixed on the body and a seat rail 102 which is movably guided thereon in the longitudinal direction L of the seat whereby a ratchet rail 107 having a number of detent openings 170 arranged in succession in the longitudinal seat direction L is fixed on the rail 101 which is fixed on the body. The seat rail 102 supports the remaining components of the seat frame, see FIG. 11.

The seat rail 102 is lockable in relation to the rail 101 fixed on the body by means of a fixing device 120. This can be a standard fixing device for a longitudinal seat adjuster. FIGS. 6 and 6a show the housing, a swivel mounted operating element 120b as well as a rotary spring of a known fixing device whose housing is fixed on the seat rail 2 with the spring acting on the operating element 120b. The rotary spring serves inter alia to take the play out of the assembly to prevent rattling noises.

The fixing device comprises for example according to DE 299 10 720 a number of locking teeth disposed inside the housing and pretensioned elastically—by means of springs mounted in the housing in the form of coil springs—towards detent devices (not visible in FIGS. 6 and 6a) fixed on a rail 1 on the body side. As a result of the pretension acting on the locking teeth the said teeth which are associated with the seat rail 102 automatically engage in the detent device which is fixed on the body so that the longitudinal adjustment of the seat is locked unless the locking teeth are brought out of engagement with the detent device by means of the operating element 120b provided for this purpose.

Since the operating element 120b of the fixing device 120 is pretensioned by means of the spring assembly 120a which consists of the springs mounted inside the housing and acting on the locking teeth, as well as the rotary spring mounted outside of the housing, against the direction into which it has to be swivelled in order to release the fixing device 120, the fixing device 120 can only then be unlocked when a force is exerted on the operating element 120b against the action of the spring assembly 120a.

In order to unlock the fixing device 120 the operating element 120b can be operated on the one hand directly by a seat user who seizes an operating handle 190 (not visible in FIGS. 6 and 6a) provided for this purpose on the said operating lever 109 which has a cross bar 190 and is attached for swivel movement to the seat frame, and swivels the handle anti-clockwise whereby the operating element 120b is moved down against the pretension of the spring assembly 120a. On the other hand the fixing device 120 can also be released by folding the seat back forwards whereby the seat back is coupled to the operating lever 109 through a Bowden cable which has a cable 121b and whose Bowden cable (not shown) is supported on a Bowden cable support 121. Furthermore a gearing part 122 is mounted on the swivel axis of the operating lever 109 by means of an axle shaft 12. The gearing part 122 has a guide 122a and a mounting 122b for the cable 121b of the Bowden cable. The gearing part converts tightening of the cable 121b when folding the backrest forwards into a swivel movement which in turn is transferred to the operating lever 109 by two arms 123 of the gearing which engage round said operating lever 109. The operating lever 109 hereby swivels round clockwise when the backrest is folded forwards and unlocks the fixing device 120 through the operating element 120b.

A cable nipple 168 is fixed, e.g. by squashing, on the cable 121b of the Bowden cable between the Bowden cable support 121 which is fixed on the seat rail by a fixing plate 121a, and the gearing 122. The cable nipple 168 is associated with a switch element in the form of a switch lever 106 which is mounted for swivel movement, by means of a bearing bush 165, a stepped bolt 165a and a screw 166, about an axis which is formed by the longitudinal axis of the stepped bolt 165a, and which (switch lever) is fixed on the seat frame or its seat rail 102. The switch lever 106 has in the upper section 161 a stop 162 which is mounted directly adjacent the cable nipple 168 and on which the cable nipple 168 can act in the longitudinal direction of the seat whereby the switch lever 106 is swivelled.

The second end section of the switch lever 106 mounted underneath the bearing bush 165 and the stepped bolt 165a forms an operating section 160 which is associated with an operating section of a locking pawl 104 of the memory device. The operating section of the locking pawl 104 is thereby formed by an operating face 140 on the top side of the locking pawl.

The shift lever 106 is here locked by a projection 191 of the operating lever 109 on which the upper section 161 of the switch lever 106 is supported vertically with a stop 163 (transversely to the longitudinal direction L of the seat), in the position shown in FIGS. 6 and 6a in which its operating section 160 acts on the operating surface 140 of the locking pawl 104. The moment required for this is applied through the spring assembly 120a of the fixing device 120 which acts on the lever projection 191 through the operating element 120b and the operating lever 109.

As an alternative or in addition the vertical position of the switch lever 106 can also be assisted by a spring mounted directly on the switch lever 106 or in that the switch lever 106 is mounted with sufficient friction which cannot be overcome by the action of the compression spring 400 of the locking pawl 104.

The locking pawl 104 itself is as can be seen in particular from FIG. 6a mounted for swivel movement on a bearing pin 155 of a slider 105 which is guided by a base body 150 movable in the longitudinal direction L of the seat next to the detent openings 170 of the ratchet rail 107. The slider has in its base body 150 a recess 152 in which a compression spring 400 is mounted which acts underneath the operating section 140 of the locking pawl 104 on the latter thereby pretensioning the said locking pawl so that a detent hook 141 mounted at the other end of the pawl 104 has the tendency to engage in the ratchet rail 107. In the situation shown in FIGS. 6 and 6a in which the seat is locked in the memory position with the backrest not folded forwards, the locking pawl is obstructed in that the operating section 160 of the switch lever 106 is supported on the operating face 140 of the locking pawl 104 so that the latter cannot swivel about the bearing pin 155 in order to bring the detent hook 141 into engagement with the ratchet rail 107.

In the situation illustrated in FIGS. 6 and 6a furthermore a counter stop 144 of the locking pawl 104 is in contact with a stop 132 of a stop element 103 which is fixed by fixing screws 136 on the seat rail 102. Furthermore a catch 143 of the locking pawl 104 which adjoins the stop 144 at the top is further located in engagement with an engagement area 134 of the stop element 103.

If the seat is in the situation illustrated in FIGS. 6 and 6a where it is locked in the memory position, and the backrest is folded forwards then the cable 121b of the Bowden cable is tensioned and moved towards the rear end (backrest side) of the seat.

Then according to FIG. 7 on the one hand the operating lever 109 is swivelled clockwise through the gearing part 122 and the arms 123 whereby it acts on the operating element 120b and releases the fixing device 120. On the other hand the cable nipple 168 which is squashed with the cable 121b moves towards the rear seat end and thereby acts on the stop 162 in the upper section 161 of the switch lever 106. The switch lever 106 is thereby swivelled anti-clockwise whereby its operating section 160 is lifted clear from the associated operating face 140 of the locking pawl 104. This swivel movement of the switch lever 106 is possible since the latter is no longer blocked by the lever projection 191 which would indeed be swivelled down together with the operating lever 109. Since the switch lever 106 has released the locking pawl 104 this is now swivelled through the action of the compression spring 400 (see FIG. 6a) about the bearing pin 155 of the slider 105 until the detent hook 141 engages in an opening 170 of the ratchet rail 107. The locking pawl 104 and thus the memory device as a whole is hereby locked.

The result of the swivel movement of the locking pawl 104 is that the catch 143 of the locking pawl 104 as well as the engagement area 134 of the stop element 103 move out of engagement. This is necessary for the seat frame to be able to move since otherwise any movement of the seat would be blocked by the locked memory device.

The cable nipple 168 thereby serves as a locking means which when the backrest is folded forwards acts on the switch lever 106 so that the locking pawl 104 cannot be unlocked by the switch lever 106.

The arrangement is designed so that when the backrest is folded forwards the detent hook 141 can already engage in a detent opening 170 through the action of the compression spring 400 before the fixing device 120 is unlocked so far that the seat rail 102 can be moved relative to the rail 101 fixed on the body. This ensures a reliable storing of the actual seat longitudinal position as the memory position. If the detent hook 141 cannot engage directly in a detent opening 170 because the seat is positioned so that the detent hook 141 under the action of the compression spring 400 strikes a web between two detent openings 170, then the detent hook 141 only engages in the next detent opening 170 it passes after a slight adjustment of the seat frame in the seat longitudinal direction L. In such a case a slight deviation occurs between the seat longitudinal position when folding the backrest forwards and the subsequently stored memory position.

In the situation illustrated in FIG. 7 which would be reached by folding the backrest forwards, the seat frame can now be moved forwards in the longitudinal direction L with the backrest folded forwards in order to make it easier for a passenger to climb into the back of the vehicle or to place an object in the back of the vehicle.

If the seat is then moved back again with the backrest still folded forwards it is at the latest stopped automatically in the memory position defined by the locking pawl 104. For on reaching the memory position the stop 132 of the seat frame moves into contact with the stop 144 of the memory device whereby a further movement of the seat frame back is prevented.

If then the backrest is again folded back into its functional position then the tension of the cable 121b and the switch lever 106 as well as the operating lever 109 with the projection 191 fixed thereon all return to their position shown in FIGS. 6 and 6a. If then the operating lever 109 is swivelled anti clockwise in order to unlock the fixing device 120 then the situation is set as illustrated in FIG. 8.

When manually swivelling the operating lever 109 by means of an operating handle provided for this purpose the fixing device 120 is indeed unlocked through the operating element 120b so that the seat frame can be moved in the longitudinal direction L on the rail 101 which is fixed on the body; however—unlike when folding the backrest forwards—the switch lever 106 hereby remains in its upright position in which its operating section 160 acts vertically on the operating surface 140. This prevents the locking pawl 104 from becoming locked through the action of the compression spring 00.

As a result of the lever projection 191 which is swivelled down according to FIG. 8, and which correspondingly does not bear against the associated stop 163 of the switch lever 106, the vertical position of the switch lever 106 has to be secured for example by a suitable configuration of the operating surface 140 of the locking pawl 104. The operating surface 140 of the locking pawl 104 can hereby be curved so that under the action of the compression spring 400 it does not exert on the operating section 160 of the switch lever 106 any moment which would result in an anti-clockwise swivel movement of the switch lever 106. In other words, the play between the operating surface 140 of the locking pawl 104 and the operating section 160 of the switch lever 106 must be designed so that the forces introduced by means of the compression spring 400 from the locking pawl 104 do not trigger any swivel movement of the switch lever 106 anti-clockwise. A swivel movement of the switch lever 106 anti-clockwise is however blocked through the cable nipple 168.

As an alternative the upright position of the switch lever 106—as already mentioned above—can also be secured by means of a suitable spring element or by sufficiently large friction forces.

In short, the actuation of the operating lever 109 in the memory position of the seat (with the backrest not folded forwards) leads on the one hand to the fixing device 120 becoming released, whilst at the same time the locking pawl 104 and thus the memory device remains overall in the unlocked state which existed already prior to swivelling the operating lever 109, see FIGS. 6 and 6a. Furthermore the catch 143 of the memory device engages in the engagement area 134 of the stop element 103 which is on the side of the seat rail.

In this state movement of the seat frame in the seat longitudinal direction L leads to the locking pawl 140 being entrained at the same time so that a new memory position is also set during displacement of the seat. The newly set memory position which corresponds to the seat longitudinal position newly set by sliding the seat frame, is however not locked just when the operating lever 109 is ultimately let go. For this has according to FIGS. 6 and 6a at first only the result that the fixing device 120 is locked and thus the seat rail 102 is stopped relative to the rail 101 fixed on the body. Locking of the memory device only happens according to FIG. 7 when in the new seat longitudinal position the seat rest is folded forwards. Then in the present embodiment the memory device is always only then locked when the seat is moved forwards with the backrest folded forwards within the easy-entry-function mode.

FIG. 9 shows the seat frame after it has first been moved forwards in the seat longitudinal direction L with the backrest folded forwards, whereby the locking pawl 104 has been allowed to return locked in the original seat position, and after the backrest has then been folded back into its function position. Furthermore the operating lever 109 is swivelled so that the fixing device 120 is unlocked and the seat frame can be moved selectively forwards or backwards in the seat longitudinal position. In each seat longitudinal position which is hereby achieved, the seat frame can be locked by means of the fixing device 120 relative to the rail 1 fixed on the body by letting go the operating lever 109.

FIG. 10 finally shows the position of the seat frame when this is moved back into the memory position with the backrest upright. The switch lever 106 hereby stops with its operating section 160 against a projection 140a which projects vertically up from the operating surface 140 of the locking pawl 104. This is due to the fact that the locking pawl 104 is located in the locked state in which it engages by its detent hook 141 (see FIG. 6a) into a detent opening 170 of the ratchet rail 107. Through the inclined position of the operating surface 140 of the locking pawl 104 which is linked to this the pawl exerts on the operating section 160 of the switch lever 106 a torque with a component parallel to the seat longitudinal direction L. As a result of this the switch lever 106 is swivelled anti-clockwise and its operating section 160 engages with the projection 140a of the locking pawl 10. This has the effect of keeping the locking pawl 104 locked when the seat lower frame reaches the memory position shown in FIG. 10.

In short the operating surface 140 accordingly interacts in the locked state of the locking pawl 10 with the operating section 160 of the switch lever 106 so that this is swivelled when the seat is pushed into the memory position with the backrest upright whereby unlocking of the locking pawl 104 is prevented. (If the seat is pushed back into the memory position with the backrest folded forwards then as a result of the action of the cable nipple 168 the switch lever 106 is then swivelled any how, see FIG. 7 so that even in this case no unlocking of the memory device can take place). On the other hand the operating surface 140 of the locking pawl 104 and the operating section 160 of the switch lever 106 interact in the unlocked state of the locking pawl 104, see FIG. 6, so that the locking pawl 104 remains unlocked, as explained above in more detail with reference to FIG. 6.

As a result of the locked state of the locking pawl 104 the seat frame on reaching the memory position is automatically stopped when the stop 132 of the stop element 103 on the seat frame side becomes blocked with the counter stop 144 of the memory device (see FIG. 6a).

If then in the memory position the operating lever 109 is let go then this is swivelled clockwise through the action of the spring assembly 120a of the fixing device 120 until the fixing device 120 is locked again. At the same time through the projection 191 of the operating lever 109 which acts on the angled stop 163 in the upper section 161 of the switch lever 106 the switch lever 106 is swivelled clockwise into its upright position whereby the switch lever 106 acts with its operating section 160 on the operating surface 140 of the locking pawl 104 and unlocks the latter (against the action of the compression spring 400)—which requires a corresponding design of the spring assembly 120a. The seat is then located again with the backrest raised up in the memory position in the state explained with reference to FIGS. 6 and 6a.

A further development according to the invention of the known vehicle seat described above with reference to FIGS. 6 to 11 will now be explained with reference to FIGS. 1 to 4. This vehicle seat and more particularly the seat frame thereby coincides with regard to the design of the longitudinal rail guide 101, 102, the design of the fixing device 120 and the design of the memory device 104, 105, 107, with the vehicle seat which has been described with reference to FIGS. 6 to 11. Further details on these features will therefore not be given. Instead for further explanations reference is made to FIGS. 6 to 11 whereby the corresponding component parts in FIGS. 1 to 4 and in FIGS. 6-11 are given the same reference numerals.

The essential characteristic features of the embodiment of the invention illustrated in FIGS. 1 to 4 lie in the design of the catch which enables an automatic re-adjustment of the memory position when the vehicle seat is moved with the backrest raised up (back rest in use position); as well as in the design of the switch means which prevent a readjustment of the memory position when the vehicle seat is moved for implementing the easy-entry function with the backrest folded forwards onto the seat surface. These two function groups of the vehicle seat will now be described in further detail with reference to FIGS. 1 to 4.

FIGS. 1 and 2 show two different perspective views of a seat longitudinal guide 101, 102 consisting of a lower rail 101 which is to be disposed fixed on the body, and an upper rail 102 which supports the seat frame. This longitudinal guide 101, 102 enables the longitudinal position of the seat to be set (position of the seat frame in the seat longitudinal direction L).

In order to lock a previously set seat longitudinal position a fixing device 120 is provided with elastically pretensioned locking teeth Z which is mounted on the seat rail 102 and whose locking teeth Z can engage in associated detent openings O of the rail 101 fixed on the body in order to lock the two rails 101, 102. Through the elastic pretension of the locking teeth Z towards the detent openings O the fixing device 120 always has the tendency to lock the two rails 101, 102 together if this is not unlocked through the action on an operating element 120b provided for this purpose. This action can—as already explained above with reference to FIGS. 6 to 11—happen on the one hand through a direct manual unlocking of the fixing device through a suitable operating lever or indirectly by folding the backrest forwards to trigger the easy-entry function. The function groups required for this have already been explained in detail with reference to FIGS. 6 to 11 so that no more details will be provided.

Furthermore FIGS. 1 and 2 together with the detailed view given in FIG. 4 show the essential constituent parts of a memory device 104, 105, 107, namely a slider 105, a locking pawl 104 mounted for swivel movement on the slider 105, as well as a ratchet rail 107 provided with detent openings 170 and in which a detent hook 141 of the locking pawl 104 can engage in order to lock a previously set memory-position. For further details on this reference is made to the description of FIGS. 6 to 11.

FIG. 3a shows a section of the seat longitudinal guide shown in FIGS. 1 and 2, namely in a situation of the seat in which this is locked in a memory position by means of the fixing device 120 when the backrest is raised up (located in a use position).

In this situation a catch 203 acts on the locking pawl 104 so that the locking pawl is lifted with its detent hook 141 clear of the ratchet rail 107. The catch 203 is mounted longitudinally displaceable on the seat rail 102 and comprises a longitudinally extended base body 230 whose lower end facing the locking pawl 104 is formed as or fitted with an entrainment element 234 which is provided with an entrainment opening 235. This catch 203 is pretensioned by means of an elastic element (compression spring) 232 which is supported on the seat rail 102 on one side and on the entrainment element 234 on the other side, in the direction of the locking pawl 104 so that it has the tendency to lift the detent hook 141 of the locking pawl 104 clear out from the ratchet rail 107. At the same time a projection 145 of the locking pawl 104 formed as a detent nose engages in the entrainment opening 235 of the entrainment member 203.

If in this state, with the backrest raised up, the fixing device 120 of the longitudinal guide 101, 102 is unlocked then with subsequent displacement of the seat rail 102 relative to the rail 101 fixed on the body the locking pawl 104 is entrained along together with the slider 105 since the locking pawl 104 does not engage in one of the detent openings 170 of the ratchet rail 107 and since furthermore the entrainment element 234 on the seat rail side engages positively by its entrainment opening 235 round the detent nose 145 of the locking pawl 104. When resetting the seat longitudinal position of the seat with the backrest raised up a new programming of the memory position takes place at the same time, as described above previously with reference to FIGS. 6 to 11.

Compared to this the memory position is to remain unchanged when the seat is moved with the backrest folded forwards in the seat longitudinal direction L for the purpose of easy-entry-function. For in this case the memory device 104, 105, 107 does indeed just serve to enable the original seat position to be found again after implementing the easy-entry function. For this purpose switch means 206 are provided which when folding the backrest forwards onto the seat surface lift the catch 203 away from the locking pawl 104.

These switch means 206 comprise a catch actuator 261 in the form of a lever which can swivel about an axis 260 on the seat rail side and which engages on a projection 231 on the base body 230 of the catch 203 and which during swivel movement in a clockwise direction can lift the catch against the action of the compression spring 232 away from the locking pawl 104. A swivel movement of the catch actuator 261 in the clockwise direction in this way is thereby triggered in that a control lever 265 which is coupled to the backrest, when folding the backrest forwards towards the seat surface is swivelled about an axis 266 on the seat rail side so that a stop 267 of the control lever 265 acts on a release lever 262 of the switch means 206 which is formed in one piece with the catch actuator 261. For coupling the control lever 265 to the backrest it is possible to use for example a Bowden cable, as described in FIGS. 6 to 10, and which likewise serves there to operate the switch means 106 which act on the locking pawl 104 of the memory device.

It is important that the control lever 265 and thus also the catch actuator 261 are only swivelled when the backrest is folded forwards to implement the easy-entry-function. A direct manual operation of the fixing device 120 through an operating lever 109 (see FIG. 6) for the purpose of resetting the seat longitudinal position with the backrest raised up (use position) on the other hand does not influence the control lever 265 or catch actuator 261.

It can be seen in FIG. 3b how the fixing device 120, the catch 203 as well as the switch means 206 behave when folding the backrest forwards onto the seat surface. On the one hand it can be seen from FIG. 3b that when folding the backrest forwards towards the seat surface the locking teeth Z of the fixing device 120 are lifted out from the associated detent openings O so that the fixing device 120 becomes unlocked. This happens in the manner described with reference to FIGS. 6 to 10 in that a gearing element coupled with the backrest acts on the operating element 120b (see FIG. 2) of the fixing device 120.

Furthermore by folding the backrest forwards the control lever 256 is swivelled clockwise whereby it acts through its stop 267 on the release lever 262 and thereby swivels the catch actuator 261 clockwise whereby in turn the catch 203 is lifted way from the locking pawl 104. The positive connection between the seat rail 102 and locking pawl 104 is hereby lifted. This means the locking pawl 104 was not entrained when moving the seat rail 102 in the seat longitudinal direction L.

Furthermore the locking pawl 104 swivels under the action of a spring element 400 (compression spring) associated with the locking pawl 104 after lifting the catch 203 about its swivel axis 155 so that the detent hook 141 of the locking pawl 104 engages in a detent opening 170 of the ratchet rail 107 which is associated with the memory device. The locking pawl 104 and thus the memory device 104, 105, 107 are hereby locked.

By unlocking the fixing device 120 when folding the backrest forwards the seat frame can now be moved in the seat longitudinal direction L whereby the memory position remains unchanged since the locking pawl 104 does indeed engage by its detent hook 141 in one of the detent openings 170 and the memory position is hereby fixed.

FIG. 4 shows the corresponding state in which the seat has been moved left in the drawing (i.e. forwards) with the backrest folded forwards, whereby the locking pawl 104 and the associated slider 105 have remained in their original position.

It can furthermore be seen from FIG. 4 that after the seat frame has been moved out from its memory position a claw-like retaining element 236 is swivelled under the action of a leg spring 236a about its axis 237 on the seat rail side so that it engages by its claw 238 about the entrainment section 235 of the catch 203 and fixes this in the raised position. This swivelling of the claw-like retaining element 236 was only possible after the seat frame has moved out from its memory position since in the memory position a stop 149 of the locking pawl 104 acts on an associated stop 239 of the claw-like retaining element 236 so that swivel movement of the retaining element 236 is prevented.

If now the seat is moved back into its memory position then when arriving at the memory position the stop 149 of the locking pawl 104 acts again on the associated stop 239 of the claw-like retaining element 236 in order to swivel this against the action of the leg spring 236a and hereby to release the catch 203 again.

It can be seen from FIG. 2 which—as in FIG. 1 and FIG. 4—shows the seat longitudinal guide 101, 102 in a situation in which the catch 203 has been lifted by means of the switch means 206 from the locking pawl of the memory device, that the catch 203 has a projection 233 which engages over a sheet metal part 120c which is connected to the operating element 120b of the fixing device 120. This sheet metal part 120c serves as a stop which blocks the catch 203 in its raised position so long as the fixing device 120 is unlocked. On renewed locking of the fixing device (e.g. after lifting up the backrest after implementing the easy-entry-function) the sheet metal part 120c swivels together with the operating element 120b of the fixing device 120 and thereby releases the catch 203 again. The catch 203 can thus only then act on the locking pawl 104 when the latter is located in its memory position and when moreover the fixing device 120 is locked in this position. Up to this moment in time on implementing the easy-entry-function the memory device is locked (locking pawl 104 engages in a detent opening 170) so that the memory position is maintained until the seat is locked properly again in this position after implementing the easy-entry function.

The design of the catch 203 according to the invention and shown in FIGS. 1 to 4 as well as the switch means 206 has the advantage that they enable a very compact arrangement of all the components which make up the memory device, namely the locking pawl 104, the slider 105 as well as the ratchet rail 107 in the space enclosed by the two seat rails 101, 102. Only the operating element 120b of the fixing device 120 as well as the switch means 206 for switching the memory device are mounted at the side next to the rails 101, 102 in order to enable their operation from outside.

FIGS. 5a to 5c show a further development of the embodiment of the invention illustrated in FIGS. 1 to 4 in which the locking pawl 104 has an additional stop 147 provided above the detent hook 141. This stop 147 on the locking pawl side is associated with a stop 127 on the seat rail side whereby these two stops can engage with each other when the locking pawl 104 does not engage by its detent hook 141 in one of the detent openings 170 of the ratchet rail 107, thus the locking device 104, 107 of the memory device is not locked.

FIG. 5a shows the memory device 104, 105, 107 in a situation where the vehicle seat is pushed with the backrest raised up (back rest in use position) in the seat longitudinal direction L whereby the locking pawl 104 and the slider 105 are entrained through the catch 203 in order to re-program the memory position according to the longitudinal position at which the seat has arrived.

If now in the longitudinal position reached by the seat the backrest of the seat is folded forwards in order to trigger the easy-entry-function, then the problem can arise that the detent hook 141 of the locking pawl 104 cannot engage in one of the detent openings 170 of the ratchet rail 107. For the fixing device 120 as a rule enables a stepless adjustment of the seat longitudinal position, see the fixing device described in DE 299 10 720 U1, whereas here a finely-stepped (thus not stepless) detent action is provided for the locking of the memory position. This case is shown in FIG. 5b where on folding the backrest forwards the detent hook 141 of the locking pawl 104 cannot engage in a detent opening 170 but stands up on its edge. At first no locking of the memory position is possible.

If now with the backrest folded forwards the seat frame and thus also the seat rail 102 are pushed forwards out from the memory position in the seat longitudinal direction (easy-entry) then the locking pawl 104 together with the slider 105 are moved along by just one piece since the stop provided on the seat rail 102 acts on the stop 147 on the locking pawl side. The locking pawl 104 and the slider 105 are thereby entrained only so far until the detent hook 141 of the locking pawl 104 can engage fully in the next detent opening 170 of the ratchet rail 107 under the action of the spring element 400. The locking pawl 104 and thus the locking device 104, 107 of the memory device 104, 105, 107 overall are thus locked in that memory position which is closest to the seat longitudinal position in which the fixing device 120 was locked before folding the backrest forwards.

This locked state of the memory device is shown in FIG. 5c. In this locked state in which the detent hook 141 of the locking pawl 104 engages in a detent opening 170 of the ratchet rail 107 the stop 147 on the locking pawl side is located underneath the stop 127 on the seat rail side so that these stops 127, 147 cannot enter into active connection with each other.

1. Motor vehicle seat with
a frame (G)
a backrest (R) which is mounted for swivel movement on the seat frame (G) and which can be folded forwards from its use position towards a seat surface of the seat frame (G),
a longitudinal guide (101, 102) with which the seat frame (G) can be moved to adjust the seat longitudinal position in the seat longitudinal direction (L),
a fixing device (120) for locking the seat frame (G) in a previously set seat longitudinal position,
an operating element (120b) for unlocking the fixing device (120) so that the seat frame (G) can be moved in the seat longitudinal direction (L),
a coupling mechanism which acts on the operating element (120b) and unlocks the fixing device (120) when the backrest (R) has been folded forwards towards the seat surface,
a memory device (104, 105, 107) by means of which when the seat frame (G) is moved in the seat longitudinal direction it can be automatically stopped in a predeterminable seat longitudinal position defined as the memory position,
adjusting means (105) of the memory device (104, 105, 107) with which the memory position can be adjusted in the seat longitudinal direction (L),
a locking device (104, 107) of the memory device (104, 105, 107) for locking a set memory position and
means (203, 206) through which the locking device (104,107) is coupled to the backrest (R)
characterised in that
on the seat frame (G) there is a movably mounted catch (203) which when the backrest (R) is located in the use position acts on the memory device (104, 105, 107) so that the memory position when setting the seat longitudinal position is displaced together with the seat frame (G) and that a catch actuator (261) is provided which is coupled to the backrest (R) and which when the backrest (R) is moved forwards lifts the catch (203) clear from the memory device (104, 105, 107).

2. Vehicle seat according to claim 1 characterised in that the catch (203) acts positively on the memory device in order, when setting the seat longitudinal position, to implement setting of the memory position at the same time.

3. Motor vehicle seat according to claim 1 or 2 characterised in that the catch (203) during action on the memory device (104, 105, 107) unlocks the locking device (10, 107) at the same time.

4. Vehicle seat according to one of the preceding claims characterised in that the catch (203) is pretensioned towards the memory device (104, 105, 107) by means of an elastic element (232).

5. Vehicle seat according to one of the preceding claims characterised in that the catch (203) is mounted longitudinally displaceable on the seat frame (G) more particularly on a rail (102) of the longitudinal guide (101, 102) on the seat side.

6. Vehicle seat according to one of the preceding claims characterised in that the locking device (104, 107) has a locking unit (104) which can be moved in the seat longitudinal direction (L) and which defines at the same time the memory position.

7. Motor vehicle seat according to claim 6 characterised in that the locking unit (104) is associated with a detent device (107) which has detent spots (170) arranged in succession in the seat longitudinal direction (L) at which the locking unit (104) can be locked relative to the detent device (107).

8. Motor vehicle seat according to claim 7 characterised in that the locking unit has a swivel mounted locking pawl (104) which has a detent element (141) which can engage at the detent spots (170) in the detent device (107).

9. Motor vehicle seat according to claim 8 characterised in that the catch (203) acts on the locking pawl (104) for unlocking the locking device (104, 107).

10. Motor vehicle seat according to claim 8 or 9 characterised in that on the locking pawl (104) there is a stop (145) on which the catch (203) acts when the backrest (R) is in a use position so that the locking unit (104) is entrained along when setting the seat longitudinal position.

11. Motor vehicle seat according to one of the preceding claims characterised in that the catch actuator (261) is formed as a lever.

12. Motor vehicle seat according to one of the preceding claims characterised in that the locking device (104, 107) for the memory device (104, 105, 107) is locked when the catch is not acting on same.

13. Motor vehicle seat according to one of the preceding claims characterised in that the catch is lifted clear from the memory device (104, 105, 107) solely during unlocking of the fixing device (120) by folding the backrest (R) forwards onto the seat surface.

14. Motor vehicle seat according to one of the preceding claims characterised in that on the seat frame (G) there is a retaining element (236) with which the catch (203) can be fixed in a position in which it is lifted clear from the memory device (104, 105, 107).

15. Motor vehicle seat according to claim 14 characterised in that the retaining element (236) is pretensioned towards the catch (203).

16. Motor vehicle seat according to claim 13 or 14 characterised in that the memory device (104, 105,107) is associated with a stop (149) which prevents fixing the catch (203) through the retaining element (236) when the seat frame (G) is located in the memory position.

17. Motor vehicle seat according to one of the preceding claims, including at least claims 1 and 7 characterised in that on the locking unit (104) of the memory device (104, 105, 107) there is a stop (147) which is associated with at least one stop (127) on the seat frame side which during displacement of the seat frame (G) in the seat longitudinal direction (L) out from the memory position entrains the locking unit (104) when this is not completely locked even if the catch (203) is lifted from the memory device (104, 105, 107), and that the stop (127, 128) on the seat frame side no longer acts on the locking unit (104) as soon as this is locked.

18. Motor vehicle seat according to claim 8 and 17 characterised in that the stop is provided on the locking pawl (104) of the locking unit.

19. Motor vehicle seat according to claim 18 characterised in that the stop (147) is brought out of engagement with the at least one stop (127) on the seat frame side when the locking pawl (104) engages by its detent hook (141) in an associated detent opening (170).

20. Motor vehicle seat according to one of claims 17 to 19 characterised in that the locking unit (104) is pretensioned towards the detent openings (170).

21. Motor vehicle seat according to claim 20 characterised in that the locking unit (104) engages automatically into the next closest detent opening (170) when the seat frame (G) is moved in the seat longitudinal direction and the catch (203) is lifted from the memory device (104, 105, 107).

22. Motor vehicle seat with
a frame (G),
a backrest (R) which is mounted for swivel movement on the seat frame (G) and which can be folded forwards from its use position towards a seat surface of the seat frame (G),
a longitudinal guide (101,102) with which the seat frame (G) can be moved in the seat longitudinal direction (L) to adjust the seat longitudinal position,
a fixing device (120) for locking the seat frame (G) in a previously set seat longitudinal position,
an operating element (120b) for unlocking the fixing device (120) so that the seat frame (G) can be moved in the seat longitudinal direction (L),
a coupling mechanism which acts on the operating element (120b) and unlocks the fixing device (120) when the backrest (R) has been folded forwards towards the seat surface,
a memory device (104, 105, 107) by means of which when the seat frame (G) is moved in the seat longitudinal direction it can be automatically stopped in a predeterminable seat longitudinal position defined as the memory position
adjusting means (105) for the memory device (104, 105, 107) with which the memory position can be adjusted in the seat longitudinal direction (L),
a locking device (104, 107) for the memory device (104, 105, 107) for locking a set memory position and
means (203, 206) through which the locking device (104, 107) is coupled to the backrest (R)
more particularly according to one of the preceding claims,
characterised in that
the longitudinal guide (101, 102) is formed by two interengaging rails (101, 102) which include a hollow cavity between same, and that the structural groups of the memory device (104, 105, 107) are mounted entirely inside this hollow cavity.
